(19) United States
(12) Patent Application Publication
(10) Pub. No.: US 2010/0138437 A1
(43) Pub. Date: Jun. 3, 2010

(54) USER TRACKING FOR BROWSER ACTIVITIES

(76) Inventors: Deepak Seetharam Nadig, San Jose, CA (US); Anil Madan, San Jose, CA (US); Sheeba Ann George, Santa Clara, CA (US); Aaron Wesley Sakowski, San Francisco, CA (US); Sanjeev Ramakumar, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/327,492

(22) Filed: Dec. 3, 2008

(51) Int. Cl. G06F 17/30

(52) U.S. Cl. 707/759; 707/E17.044; 707/E17.108

(57) ABSTRACT

A method and a system to track a user's browser activity may include retrieving a stored navigation string for cached webpages from a user device, the stored navigation string including one or more past tracking combinations associated with the cached webpages on the user device. The stored navigation string may be analyzed to detect user requests for the cached webpages. The user requests may be stored in a user activity database on a provider device and webpages may be modified stored on the provider device based on the user requests stored in the user activity database.

### TECHNICAL FIELD

The present application relates generally to the technical field of internet activity tracking.

### BACKGROUND

The Internet allows users to view many different websites. Each website may have many different webpages associated with the website. While viewing a webpage a user may often go back and forth between previously viewed webpages. A user may also refresh the currently viewed webpage. A user may also click on links that take the user from one webpage to another webpage.

### BRIEF DESCRIPTION OF THE DRAWINGS

Some embodiments are illustrated by way of example and not limitation in the figures of the accompanying drawings in which:

FIG. 1 is a diagram of an example system to track a user's browser activity.

FIG. 2 is an example user interface.

FIG. 3 is an example diagram of a user device.

FIG. 4 is an example diagram of a provider device.

FIG. 5 is an example flowchart describing a method to track a user's browser activity.

FIG. 6 is an example flowchart describing a method to determine a user action.

FIG. 7 is an example flowchart describing a user viewing a webpage.

FIG. 8 is an example diagram illustrating opening a new window.

FIG. 9 is an example machine diagram.

### DETAILED DESCRIPTION

Example methods and systems for User Tracking For Browser Activities are described. In the following description, for purposes of explanation, numerous specific details are set forth in order to provide a thorough understanding of example embodiments. It will be evident, however, to one skilled in the art that the present invention may be practiced without these specific details.

In an example embodiment, when a user is using the Internet he/she may use a web browser (such as Mozilla's Firefox or Microsoft's Internet Explorer) on a user device such as a personal computer. When a user is browsing a particular website there may be one or more webpages associated with the website. The operator/owner of the website may wish to track the user's activity on their website. This may be done for multiple reasons, including, but not limited to, enhancing the layout of the website and determining how long a user is looking at a particular page. Often, when a user clicks on a link in their web browser, a request is sent to the provider of the associated website (e.g., through the Internet). In an example embodiment, the provider is a provider device including a web server. Because, in an example embodiment, the request is actually sent to the web server, the web server may store and track at least this aspect of a user's browser activity. However, in some instances it may be difficult to track a user if the user uses the back/forward controls that are available on some web browsers. In an example embodiment, when a user visits a webpage, a cached version of the webpage may be stored on the user device. When a user clicks back/forward in their web browser, instead of sending a new request to the web server, the user device may use the cached version of the web site. Thus, in an example embodiment, the web server cannot track the user activity if the back/forward controls are used or if an action is taken that does not result in a request to the web server.

Because of the difficulty in tracking the complete history of user's browser activity, an example embodiment may allow collection of a more complete history of the user. In an example embodiment, each user action is tracked on the user device. User actions may include, but are not limited to back, forward, click, or refresh actions. The tracking may include generating an instance identification (also called an instance-id) which, when combined with a page identification (also called a page-id), creates a tracking combination that identifies the user's request. In an example embodiment, webpages contain tracking instructions to store the tracking combination in a tracking variable and in a tracking object, e.g., a user cookie. A cookie may be accessible from any webpage that the web server controls, while the tracking variable may only be associated with a single webpage. In an example embodiment, after a webpage is loaded into the browser, a check may be made to see if the tracking variable matches the cookie value. If the two values are the same, the user action may be considered a refresh or click request. If the two values are different, the tracking variable is appended to the cookie in the form of the tracking combination. The next time the user action sends a request to the web server, the web server will retrieve all the tracking combinations that have been stored in the cookie. In an example embodiment, the combinations stored in the cookie may collectively be called a navigation string. This navigation string may be analyzed to determine the user's actions associated with the user's requests.

### Architecture

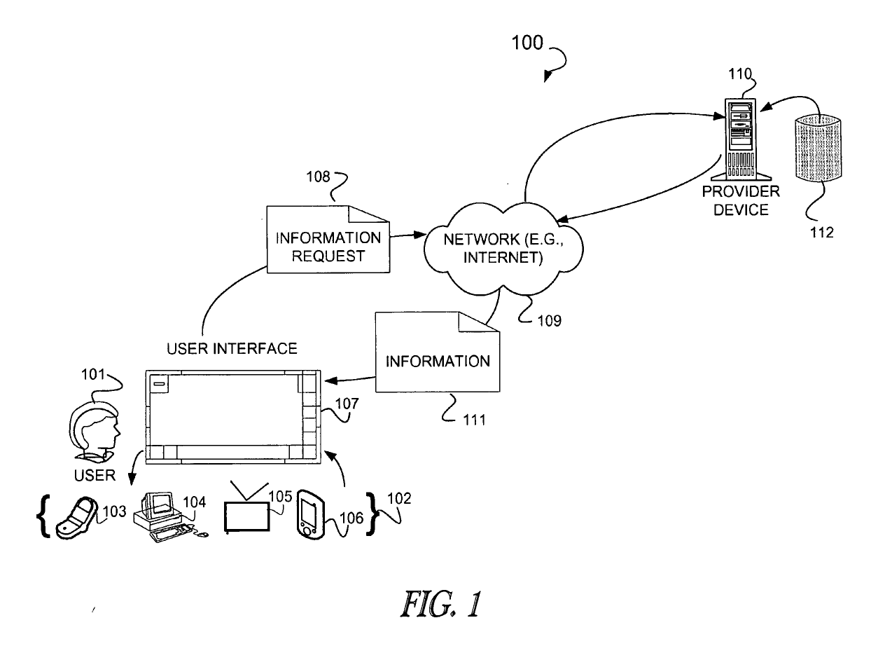

FIG. 1 is a diagram of an example system 100 to track a user's browser activity. Shown is a user 101, utilizing a user interface 107 that resides on any one of a number of user devices 102. These devices 102 may include, for example, a cell phone 103, a computer system 104, a television 105, and/or a Personal Digital Assistant (PDA) 106. The user device 102 may be connected to a network 109 (e.g., the Internet). Also shown is a provider device 110 that may be connected to network 109. A user activity database 112 may be coupled to the provider device 110. In an example embodiment, the user 101 may use the user interface 107 to send an information request 108 to the provider device 110 through network 109 and receive information 111. In an example embodiment, the information request 108 is a request for a webpage stored on provider device 110. In an example embodiment, provider device 110 is a web server. It will be appreciated that the present invention may be relevant to other applications, but the following sections will assume the example of the user 101 using a personal computer as the user device 102 and an internet browser (such as Internet Explorer distributed by Microsoft) as the user interface 107. In an example embodiment, the user activity database 112 stores the information requests 108 made by user 101. The user activity database 112 may also include tracking combinations that have been generated for the user as well as past user actions.

In some example embodiments, the information request 108 may be sent to more than one provider device 110. Further, provider device 110 may be connected to a plurality of additional provider devices. Additionally, provider device 110 may be connected to a plurality of other databases in addition to user activity database 112. Further, though not depicted, this provider device 110 and/or plurality of provider devices may be operatively coupled to any one of a number of databases that may serve as an intermediary between the provider device 110 and databases such as the user activity database 112

The user device 102 may communicate the information request 108 to network 109 in one or more manners. Some examples may include, but are not limited to, direct wired communication (e.g., through an Ethernet connection) and wireless communication (e.g., 802.11a/b/g/n). In another example embodiment, the user device 102 may communicate through a network hub or router which then communicates with network 109.

In an example embodiment, the provider device 110 may communicate with network 109 in one or more manners. Some examples may include, but are not limited to, direct wired communication (e.g., through an Ethernet connection) and wireless communication (e.g., 802.11a/b/g/n). In another example embodiment, the provider device 110 may communicate through a network hub or router which then communicates with network 109.

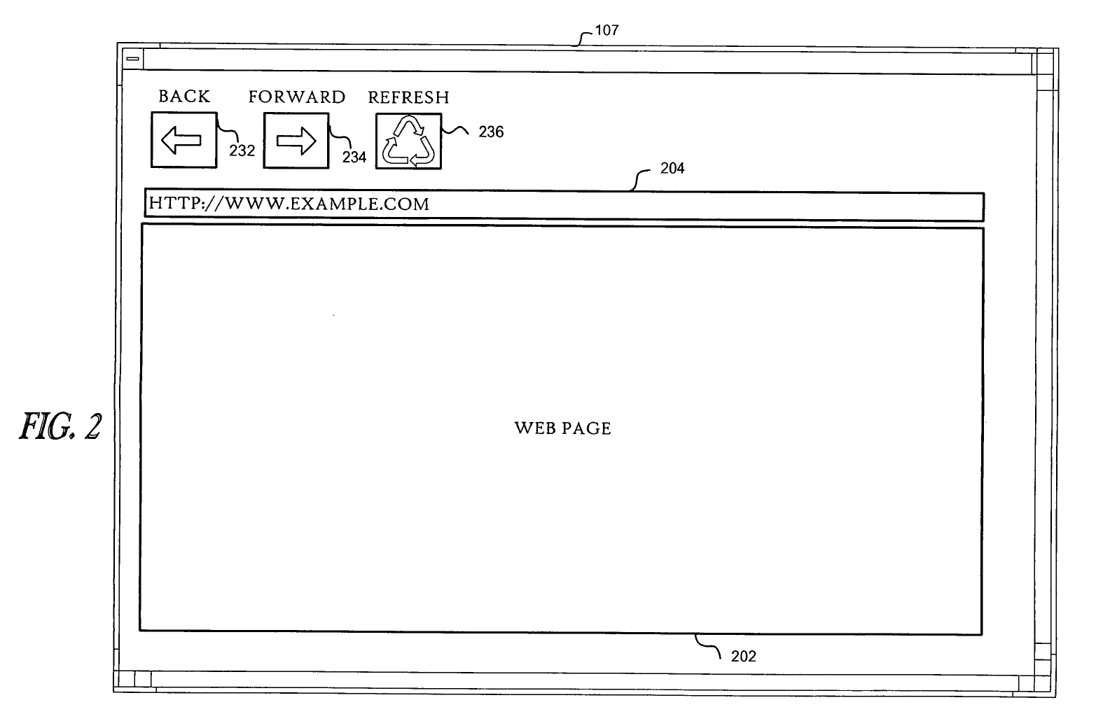

FIG. 2 illustrates an example user interface 107. As discussed above, the user interface 107 may be a browser application. In an example embodiment, the user interface 107 contains a plurality of activity controls such as back control 232, forward control 234, and refresh control 236. Also shown is a webpage 202 and the Uniform Resource Locator (URL) 204 for the webpage 202. In an example embodiment, if a user wishes to navigate to a previously visited webpage, the user may click on back control 232 and the user interface 107 may display the previously visited website. Similarly, if the user wishes to then navigate to a more recently visited webpage, the forward control 234 can be activated and the user interface 107 may display the requested webpage. Also, in an example embodiment, the user may active the refresh control 236 to reload the currently displayed webpage.

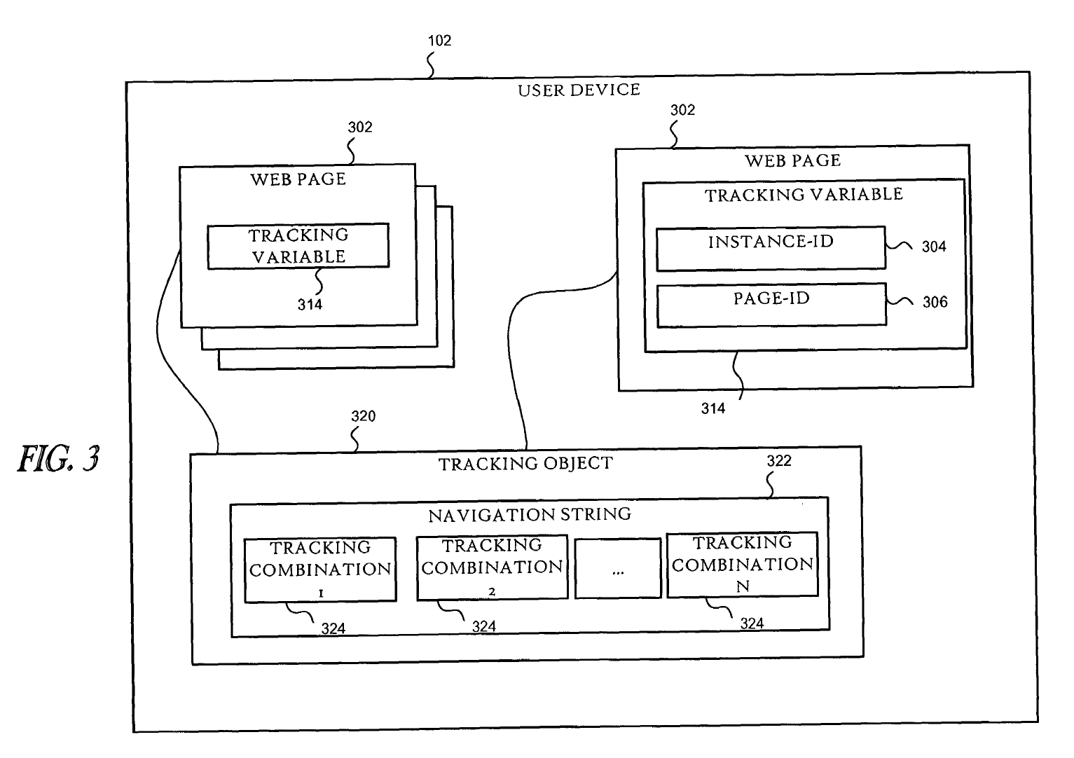

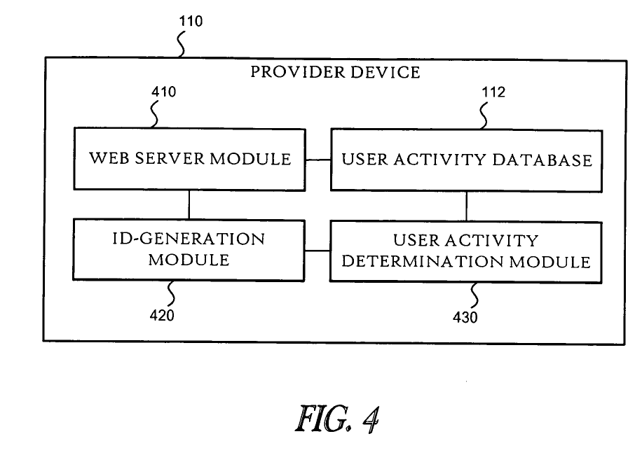

FIG. 3 illustrates an example representation of a user device 102 according to an example embodiment. Shown are multiple webpages 302 that may be cached on the user device after receiving them from a provider device (e.g., 110). In an example embodiment, webpages 302 are defined using markup language such as Hypertext Markup Language (HTML). Webpage 302 may also include components defined using a scripting language such as JavaScript. In an example embodiment, a tracking variable 314 may be associated with a webpage 302. The tracking variable 314 may include an instance-id 304 and a page-id 306. As will be more fully discussed with reference to FIG. 4, a page-id may define the actual page the user has visited and an instance-id may be an identification generated that uniquely defines a request for the specified webpage. User device 102 may also include a tracking object 320. Tracking object 320 may conform to a Hypertext Transfer Protocol (HTTP) cookie. In an example embodiment, the tracking object 320 may include a navigation string 322 that contains one or more tracking combinations 324. The navigation string 322 may, for example, contain one or more tracking combinations 324 that are associated with webpages 302.

FIG. 4 illustrates an example embodiment of a provider device 110. The provider device 110 may include a web server module 410, an ID-Generation module 420, a user activity determination (UAD) module 430, and a user activity database 112. The modules 410, 420, and 430 and database 112 may also be communicatively coupled to each other, allowing any module to transmit and receive information from any other module as well as database 112.

In an example embodiment, the webpage server module 410 responds to requests for webpages stored on provider device 110. Referring to the example of a user using a personal computer, a user may request one or more webpages over the course of a browsing session. The webpage server module 410 may process the user request and send the contents of the requested page to the user device. Also, the webpage server module 410 may send an instance-id generated by the ID-generation module 420 to the user device. In a farther example embodiment, the webpage server module 410 receives a navigation string from the user device and stores the navigation string in the user activity database 112. The navigation string may contain one or more tracking combinations. In an example embodiment, a tracking combination includes an instance-id and a page-id, wherein the page-id identifies the requested webpage.

The ID-generation module 420 may serve the function of generating the instance-id for a user's webpage request. In an example embodiment, an instance-id is one half of the tracking combination that may uniquely identify a user's webpage request. The other half of the tracking combination, a page-id, may be retrieved from the request itself. In other example embodiments, the user device may generate the instance-id.

In an example, the instance-id may be generated using the current time or may be a randomly generated number. For example, if a user requests a webpage at 5:55 pm on Jan. 1, 2001, the instance id may be generated as “0555010101.” If the instance-id is randomly generated, it may be large enough to ensure that an instance-id will not be repeated. In an example embodiment, the page-id may be the URL (e.g., http://www.example.com/page1.html). In another example, the page-id may be a number assigned to the requested page. In a further example embodiment, the page-id may be an encrypted version of the URL.

In yet another example embodiment, the user activity determination module 430 analyzes the entries stored in the user activity database 112. Each entry may contain a navigation string of tracking combinations. In an example, the navigation string may be parsed such that each entry stored in the user activity database 112 contains only one tracking combination. In an example embodiment, the entries are stored in the order in which they were received at the provider device 110. This may allow the user activity determination (UAD) module 430 to examine a user's actions in the same order the user made them. For example, assume there is a first entry that has the combination [A, 1], with ‘A’ referring to the page-id and ‘1’ referring to the instance-id, and an example second entry with the combination [A, 3]. The UAD 430 may analyze the first entry and determine that the user action was a click activity. This may be because there were no previous entries, implying that this was the first time the user requested the page. The UAD 430 may analyze the second entry and determine that the user action was a refresh activity. This may be deduced by noting that the page-id was identical for the two entries, but the instance-id was different. More complex analysis may be done using the UAD 430, as will be more fully explored in future disclosed example embodiments.

In further example embodiments, the UAD may include entries with multiple tracking combinations that include additional information such as a timestamp as shown in the examples below.
[timestamp 1] [pageid A] [instanceid 1] (first server request)
[timestamp 2] [pageid B] [instanceid 2] (second server request)
[timestamp 3] [pageid C] [instanceid 3] [clienttracking [pageid A:instanceid 1]] (third server request)
   This information may be stored in a raw format or may be parsed into a format such as which reflects the inferred click order:
[timestamp 1] [pageid A] [instanceid 1] (first server request)
[timestamp 2] [pageid B] [instanceid 2] (second server request)
[timestamp 3] [pageid A] [instanceid 1] (intermediate client activity)
[timestamp 3] [pageid C] [instanceid 3] (third server request)

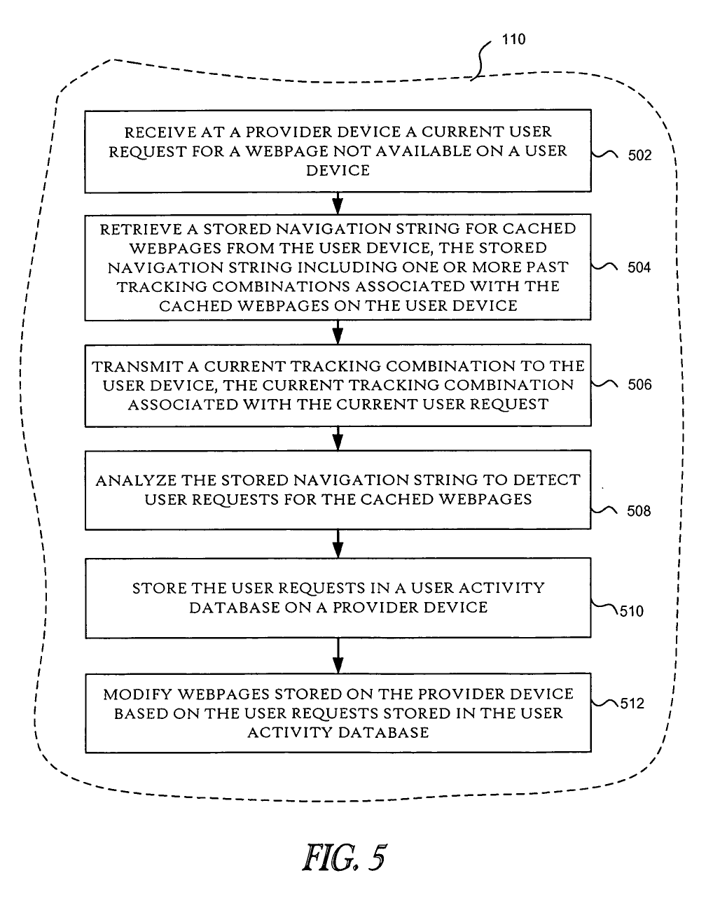

An example method to track a user's browser activity is illustrated in FIG. 5. In an example embodiment, the method may be implemented using provider device 110. At block 502, a current request for a webpage not available on a user device is received at a provider device.

At block 504, in an example embodiment, a stored navigation string for cached webpages is retrieved from a user device, the stored navigation string including one or more past tracking combinations associated with the cached webpages on the user device. Each past tracking combination may include an associated instance identification and page identification (instance-id and page-id). The sequence of tracking combinations may be delineated by characters such as ‘:’ or ‘;’ or brackets. An example string may appear as, for example:

[page1, R00001]: [page2, R00002]

In further example embodiments, the provider device may separate out the individual combinations and place them into a data structure such as an array or a database. This may allow comparison of each combination found in the navigation string.

At block 506, in an example embodiment, a current tracking combination is transmitted to the user device, the current tracking combination associated with the current request. Responsive to a user device request for information such as a webpage, the user device request may be uniquely identified by forming a current tracking combination, including a generated instance identification and a page identification indicating a cached webpage stored on the user device. An instance-id may be generated for each request received at the provider device, even if it is for the same webpage. In this manner, the system may still be able to determine whether there was user activity when the combinations are analyzed. As discussed above, with reference to FIG. 4, there are many ways to generate the instance-id. This may include, in an example embodiment, generating an instance identification for the current tracking combination which uniquely identifies the current user request.

In an example embodiment, the page-id may serve the purpose of identifying the information the user is requesting from the provider device. The page-id may be embedded in the request in the form of the address of the specific webpage. In another embodiment, the page-id may be stored on the provider device as a mapping of a webpage to a string. For example, the provider device may map the page “example.com/page1.html” as page-id “page1” and “example.com/page2.html” as “page2.” Thus, as described above, a tracking combination may take on many forms. For example, it may look like [page1, R00001] or [example.com/page1, 01012008]. It may be appreciated that in an example embodiment, instance-ids will rarely, if ever, be repeated, but page-ids may be, and likely will be, reused.

In an example embodiment, tracking instructions are transmitted to the user device, the instructions at least indicating a request to associate the current tracking combination with the webpage requested by the user device. In an example embodiment, the tracking combination is stored in a tracking variable associated with the webpage requested. The tracking variable, as described above, may be a JavaScript variable. Because of the way JavaScript may operate, the current tracking combination will stay associated with the requested webpage even if a user clicks ‘back’ or ‘forward’ on the user interface (e.g., elements 232, 234 in FIG. 2). The first tracking combination may also be stored in a tracking object on the user device. This may allow construction of a navigation string stored in the tracking object that mirrors the user's actions.

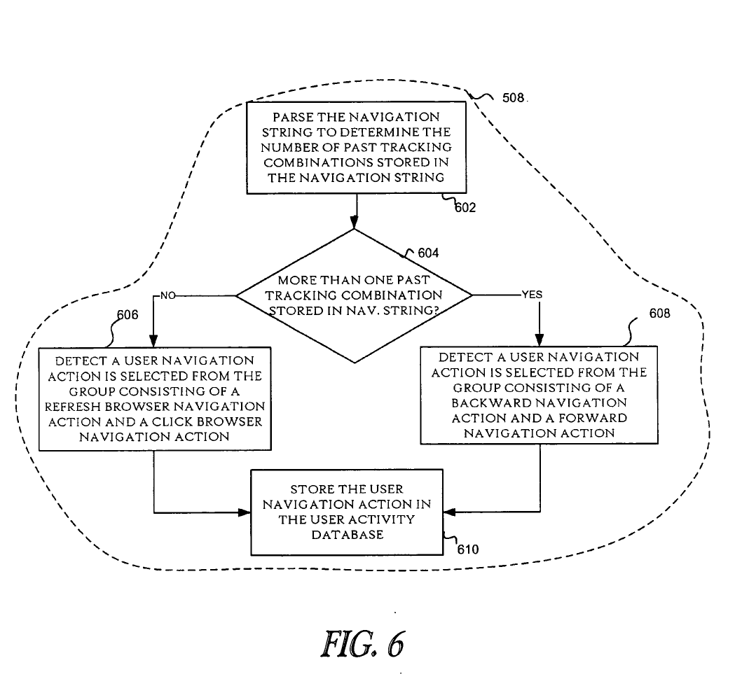

At block 508, the navigation string is analyzed to detect user requests for the cached webpages. Because, in an example embodiment, previously visited webpages may be locally available on the user device, the user device will not send a request to the provider device. In an example, a first tracking combination associated with a first webpage navigated to by a user on the user device is retrieved from the stored navigation string. Also, a second tracking combination associated with a second webpage navigated to by a user on the user device may be retrieved from the stored navigation string. The first tracking combination and the second tracking combination may be compared to detect a user browser navigation action linking the first webpage to the second webpage. For example, if the navigation string contains the first tracking combination [page1, R00001] and the second tracking combination is [page1, R00002] the two combinations may be compared. In an example embodiment, the user browser navigation action may include an action taken on the user device which loads a cached webpage. Detecting the precise user action is discussed in further detail with reference to FIG. 6. The resulting user browser navigation action may be stored in the user activity database.

At block 510, in an example embodiment, the user requests may be stored in a user activity database on the provider device. The stored data may also include the associated user action for the request. In a further example embodiment, the actions may be recorded in a user data file that maintains a history of the user's actions. Once data is collected on many users, the user data files may be examined together to see patterns in user behavior. A user interface may be provided that displays the data collected. Analyzing these patterns may lead to a developer making changes in the structure of a website. For example, if the pattern [A, 1] [B, 2] [A, 1] [C, 3] is repeatedly seen, it may appear that users are consistently going back to page A from page B in order to get to page C. This may mean that there is no direct link to page C from page B, and it may be beneficial to the website developer to add a link from B to C. At block 512, modifications of webpages stored on the provider device based on the user requests stored in the user activity database may be made. This may include, in an example embodiment, adding a link between pages B and C.

FIG. 6 illustrates an example method to determine a user action (e.g., block 508 with reference to FIG. 5). The analysis performed to determine the user action may be done in a user activity determination module such as module 430 with reference to FIG. 4. There may be multiple ways to determine a user's actions based on a retrieved navigation string, and the method described in FIG. 6 presents an example embodiment.

At block 602, in an example embodiment, the navigation string is parsed to determine the number of past tracking combinations stored in the navigation string. The navigation string may be retrieved directly from a user device or it may be retrieved from a user activity database (e.g., user activity database 112). As discussed above, tracking combinations may be character-delineated, thus allowing for quick separation and counting of the tracking combinations. At 604, it is determined whether there is more than one past tracking combination stored in the navigation string.

If it is determined at block 604 that there is one tracking combination in the navigation string, then the method continues at block 606, where a user action is detected to be selected from the group consisting of a refresh browser navigation action and a click browser navigation action. As discussed previously, a user device may transmit a tracking combination for each user request received at the provider device. In an example embodiment, the navigation string stored in the tracking object is cleared after each new user request, such that only the current tracking combination will be present in the navigation string. Thus, in an example embodiment, the only action the user may be taking is either a click action or a refresh action, because only those actions request information from the provider device.

In some example embodiments, it is further determined whether the user action is a refresh browser navigation action or a click browser navigation action. This may be done, for example, by examining the previous user actions from the user activity database. If the page-id from the previous action is the same as the page-id from the navigation string, then the action may be considered a refresh browser navigation action. If the page-ids do not match or there is no previous action stored, the user action may be considered a click browser navigation action. At block 610, the user navigation action may be stored in the user activity database.

If it is determined at block 604 that there is more than one tracking combination in the navigation string, then the method continues at block 608, in an example embodiment, where a user action is detected to be a user action selected from the group consisting of a backward navigation action and a forward navigation action. Because, in an example embodiment, only back and forward actions include appending tracking combinations to the navigation string, it can be assumed that if there is more than tracking combination then the user action is a back or forward action.

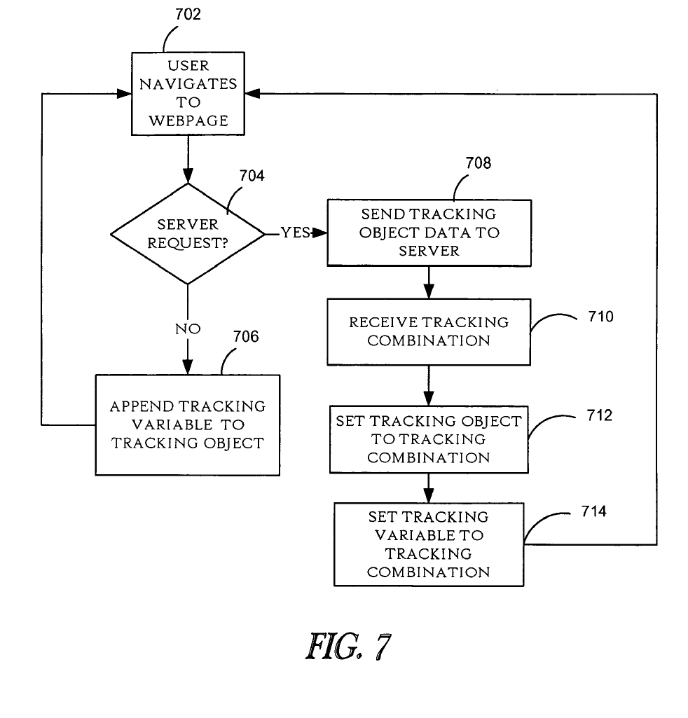

In an example embodiment, when a user device loads a webpage, the tracking variable associated with the webpage is compared with the tracking object. If the user device is using a cached version of the webpage, the tracking variable associated with the webpage will not have the same value as the tracking object. In an example embodiment, the tracking variable will be appended to the navigation string in the form of a tracking combination. This process is explored more fully with reference to FIG. 7.

In a further example embodiment, the stored navigation string can be analyzed to determine if the first user action is a backward navigation action or a forward navigation action. For example, assume the first navigation string received at the provider device only contains the tracking combination [A, 1]. Because there is no other user action history, the provider device may store the user action as a click navigation action. Then, the next navigation received string is [B, 1], [A, 1]. It can be deduced that the next actions the user took were a click navigation action to get to page B, followed by a backward navigation action to page A. It may be determined the action was a backward navigation action and not a forward navigation action because page-id A occurred before page-id B in the user action history. At block 610, the user navigation action may be stored in the user activity database.

### Client Side

In an embodiment, the method illustrated in FIG. 7 shows the operation of an example embodiment from the user device's perspective. In an example embodiment, at block 702, the user navigates to a webpage. This may be done by opening up a new window, clicking on a link, clicking on a back or forward control, clicking a refresh control, or any other activity that results in a webpage being viewed.

At block 704, in an example embodiment, it is determined whether the user navigating to the webpage included a request for a webpage stored on a provider device. After the webpage is received and loaded, the tracking variable (e.g., tracking variable 314) may be compared to the tracking object (e.g., the navigation string in the tracking object). If the values are the same, a provider device request has been made. This is because, in an example embodiment, upon a provider device request, the device request includes instructions to set the tracking variable and tracking object to the received tracking combination (see block 708).

At block 706, in an example embodiment, it is determined that there was no provider device request and the tracking variable associated with the webpage is appended to the tracking object. In an example embodiment, the tracking variable is formatted to be in the same format as tracking combinations (see e.g., FIG. 5). In another example embodiment, it is determined that the tracking object is full (e.g., the cookie has reached its maximum allowed size). The tracking object data may be transmitted to the provider device and the tracking object may be reset.

At block 708, in an example embodiment, tracking object data is sent to the provider device. The tracking object data may include the navigation string. At block 710, in an example embodiment, it is determined that there was a provider device request and the user device receives a tracking combination. The tracking combination may come from the user device or from the provider device. As discussed above, the tracking combination may include a page-id and an instance-id. At block 712, in an example embodiment, the tracking object is set to the tracking combination. In an example embodiment, the navigation string included in the tracking object may be set to the tracking combination value. At block 714, in an example embodiment, the tracking variable associated with the webpage is set to the tracking combination.

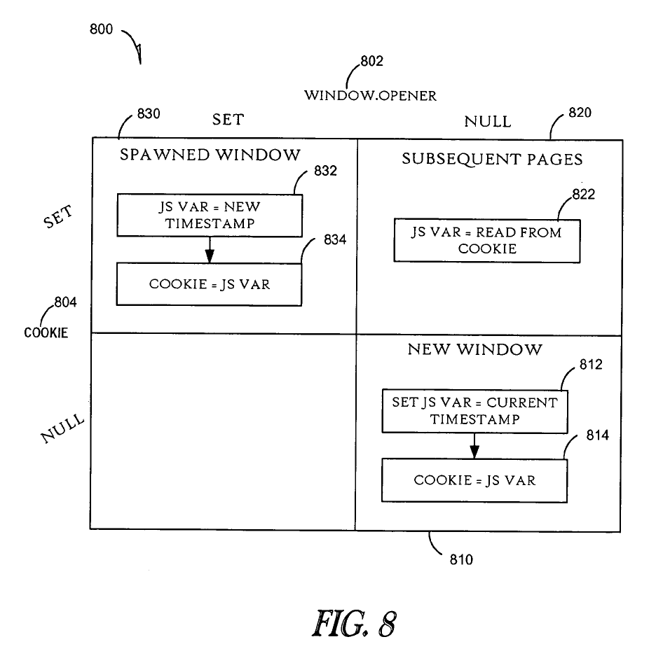

Referring now to FIG. 8, diagram 800 illustrates an example method to track user activity across new windows. It may be helpful to know when a user is opening a new window for the same reasons as tracking a user's browser activities. The example embodiment illustrated uses JavaScript and Cookies to track when a user opens a new window. However, there may be other example embodiments which utilize other programming languages and internet objects.

In particular, diagram 800 illustrates the actions a user's device may perform when a page is first viewed. Boxes 810, 820, and 830 represent the differing combinations of a window.opener variable 802 and cookie 804. In an example embodiment, window.opener variable 802 may contain a value of what the user was looking at before opening up a new window. For example, if a user is browsing a page on eBay.com using Internet Explorer, right-clicks on a link, and selects “Open in new window,” window.opener variable 802 may now have a value that is associated with eBay.com. If, on the other hand, a user selects “New Window” from the File menu, there may be no value associated with window.opener variable 802.

If window.opener variable 802 is null (e.g., has not been set to anything) and the cookie 804 is also null, then the user action may be a new window action as show in box 810. At block 812 a JavaScript variable is set to the current timestamp, and at block 814 the cookie is set to the same JavaScript variable.

If window.opener variable 802 is null and cookie 804 has a value set, then the user action may be a subsequent pages action as shown in box 820. This may include actions such as clicking on links, refreshing, using “back,” and using “forward.” When the action is determined to be a subsequent pages action, then at block 822 the JavaScript variable may set by using the value in the cookie 804.

If window.opener variable 802 and cookie 804 both have values set, then the user action may be a spawned window event as shown in box 830. A spawned window event may be an event in which a user is visiting a website and opens up a link in a new window. At block 832, a JavaScript Variable is set to a new timestamp, and at block 834 a cookie 804 is set to the JavaScript Variable. Upon setting the JavaScript variable to the cookie, the window.opener variable is reset so that subsequent pages in the same window will maintain the window id as a constant.

In an embodiment, when the user leave a page (e.g., closes the window or navigates to another page) cookie 804 is set to the value of the JavaScript variable. Similarly, upon the “OnUnload” phase of a page, the cookie should be set to what is in the JavaScript variable. This allows the system to pick the correct value of window id from the JavaScript variable and set it back to the cookie. In an example embodiment, this step is completed as the cookie would have been overwritten by other windows as spawned windows in the same cookie space.

### Machine Diagram

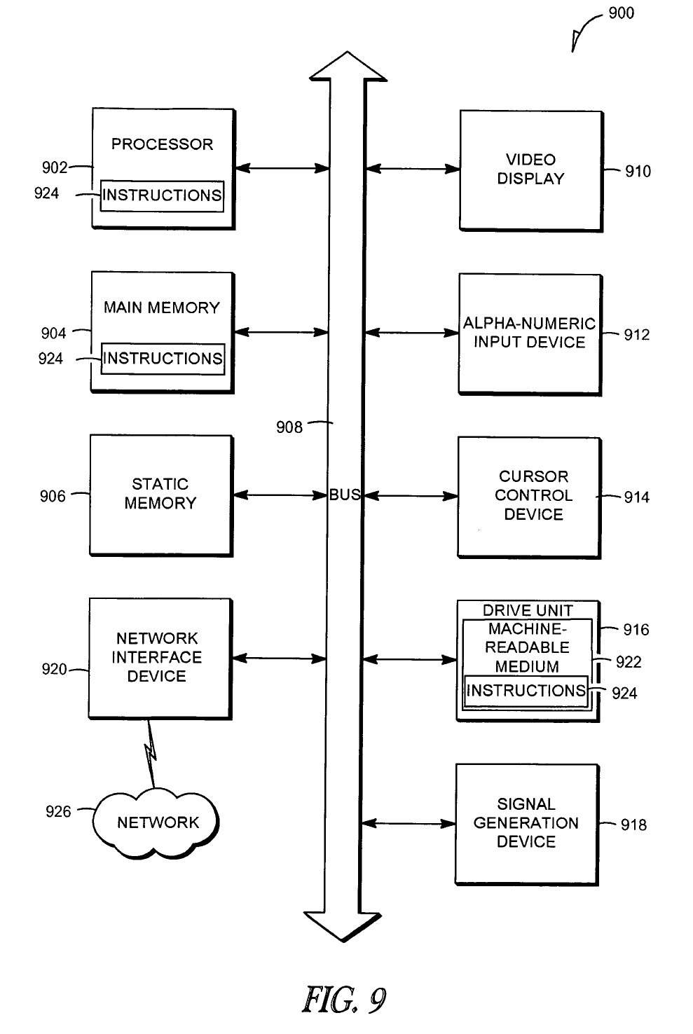

FIG. 9 shows a diagrammatic representation of a machine in the example form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU) a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions (e.g., software 924) embodying any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media. The software 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. In an example embodiment, the machine-readable medium is a computer-readable medium. The term “machine-readable medium” shall accordingly be taken to include, but not be limited to, solid-state memories, optical and magnetic media, and carrier wave signals.

Thus, a method and system to track a user's browser activity has been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method, the method comprising:
retrieving a stored navigation string for cached webpages from a user device, the stored navigation string including one or more past tracking combinations associated with the cached webpages on the user device;
analyzing the stored navigation string to detect user requests for the cached webpages;
storing the user requests in a user activity database on a provider device; and
modifying webpages stored on the provider device based on the user requests stored in the user activity database.

2. The method of claim 1, further comprising:
receiving at the provider device a current user request for a webpage not available on the user device.

3. The method of claim 2, further comprising:
transmitting a current tracking combination to the user device, the current tracking combination associated with the current user request.

4. The method of claim 3, wherein transmitting the current tracking combination to the user device further comprises:
generating an instance identification for the current tracking combination which uniquely identifies the current user request.

5. The method of claim 1, wherein analyzing the stored navigation string comprises:
retrieving a first tracking combination associated with a first webpage navigated to by a user on the user device from the stored navigation string;
retrieving a second tracking combination associated with a second webpage navigated to by a user on the user device from the stored navigation string;
comparing the first tracking combination and the second tracking combination to detect a user browser navigation action linking the first webpage to the second webpage; and
storing the user browser navigation action in the user activity database.

6. The method of claim 5, wherein the user browser navigation action includes an action taken on the user device which loads a cached webpage.

7. The method of claim 1, wherein analyzing the stored navigation string further comprises:
parsing the navigation string to determine the number of past tracking combinations stored in the navigation string;
based on the number of past tracking combinations stored in the navigation string being equal to one, detecting a user navigation action is selected from the group consisting of a refresh browser navigation action and a click browser navigation action; and
storing the user navigation action in the user activity database.

8. The method of claim 1, wherein analyzing the stored navigation string further comprises:
parsing the navigation string to determine the number of past tracking combinations stored in the navigation string;
based on the number of past tracking combinations stored in the navigation string being greater than one, detecting a user navigation action is selected from the group consisting of a backward navigation action and a forward navigation action; and
storing the user navigation action in the user activity database.

9. The method of claim 1, wherein at least one of the one or more past tracking combinations includes a first tracking combination including an associated instance identification and a page identification indicating a cached webpage stored on the user device.

10. A system comprising:
a processor operable to execute instructions;
a memory device holding data including instructions operable on the processor, the instructions operable to manage:
retrieving a stored navigation string for cached webpages from a user device, the stored navigation string including one or more past tracking combinations associated with the cached webpages on the user device;
analyzing the stored navigation string to detect user requests for the cached webpages;
storing the user requests in a user activity database on a provider device; and
modifying webpages stored on the provider device based on the user requests stored in the user activity database.

11. The system of claim 10, wherein the memory device holding data includes further instructions operable to manage receiving at the provider device a current user request for a webpage not available on the user device.

12. The system of claim 11, wherein the memory device holding data includes further instructions operable to manage transmitting a current tracking combination to the user device, the current tracking combination associated with the current user request.

13. The system of claim 12, wherein transmitting the current tracking combination to the user device further comprises:
generating an instance identification for the current tracking combination which uniquely identifies the current user request.

14. The system of claim 10, wherein analyzing the stored navigation string comprises:
retrieving a first tracking combination associated with a first webpage navigated to by a user on the user device from the stored navigation string;
retrieving a second tracking combination associated with a second webpage navigated to by a user on the user device from the stored navigation string;
comparing the first tracking combination and the second tracking combination to detect a user browser navigation action linking the first webpage to the second webpage; and
storing the user browser navigation action in the user activity database.

15. The system of claim 14, wherein the user browser navigation action includes an action taken on the user device which loads a cached webpage.

16. The system of claim 10, wherein analyzing the stored navigation string further comprises:
parsing the navigation string to determine the number of past tracking combinations stored in the navigation string;
based on the number of past tracking combinations stored in the navigation string being equal to one, detecting a user navigation action is selected from the group consisting of a refresh browser navigation action and a click browser navigation action; and
storing the user navigation action in the user activity database.

17. The system of claim 10, wherein analyzing the stored navigation string further comprises:
parsing the navigation string to determine the number of past tracking combinations stored in the navigation string;
based on the number of past tracking combinations stored in the navigation string being greater than one, detecting a user navigation action is selected from the group consisting of a backward navigation action and a forward navigation action; and
storing the user navigation action in the user activity database.

18. The system of claim 10, wherein at least one of the one or more past tracking combinations includes a first tracking combination including an associated instance identification and a page identification indicating a cached webpage stored on the user device.

19. A tangible machine-readable medium embodying instructions which, when executed by a machine, cause the machine to perform a method comprising:
retrieving a stored navigation string for cached webpages from a user device, the stored navigation string including one or more past tracking combinations associated with the cached webpages on the user device;
analyzing the stored navigation string to detect user requests for the cached webpages;
storing the user requests in a user activity database on a provider device; and
modifying webpages stored on the provider device based on the user requests stored in the user activity database.
